(19) United States
(12) Patent Application Publication
(10) Pub. No.: US 2015/0370211 A1
(43) Pub. Date: Dec. 24, 2015

(54) SHEET MOISTURIZING APPARATUS AND IMAGE FORMING SYSTEM

(71) Applicant: Konica Minolta, Inc., Tokyo (JP)

(72) Inventor: Masanobu SAITOU, Saitama-shi (JP)

(21) Appl. No.: 14/734,628

(22) Filed: Jun. 9, 2015

(30) Foreign Application Priority Data
Jun. 18, 2014 (JP) 2014-125182

(51) Int. Cl. G03G 15/00

(52) U.S. Cl. CPC G03G 15/6538

(57) ABSTRACT

A sheet moisturizing apparatus includes a moisturizing section, a water feeding section and a control section. The moisturizing section includes a pair of moisturizing rollers that moisturizes a sheet and a driver that rotates the pair of moisturizing rollers. The water feeding section feeds water to an outer peripheral surface of the pair of moisturizing rollers. The control section controls the water feeding section to feed water only to a predetermined part of the outer peripheral surface of at least one of the pair of moisturizing rollers, and thereafter allows the rotating pair of moisturizing rollers to pinch the sheet so as to bring the predetermined part into contact with a sheet finishing area of the sheet.

### BACKGROUND OF THE INVENTION

1. Field of the Invention

The present invention relates to a sheet moisturizing apparatus and an image forming system.

2. Description of Related Art

Sheet finishing apparatuses that apply various sheet finishing such as punching, binding and folding to sheets have been known in the art. In recent years, it has been increasingly required to apply such sheet finishing to cardboards and stiff sheets.

When a sheet finishing apparatus frequently processes cardboards and stiff sheets, it is required to improve the durability of the driver systems of its sheet finishing mechanisms because they are subjected to a great load. However, improving the durability is costly.

Accordingly, it has been considered to moisture a cardboard or a stiff sheet to reduce the stiffness of the sheet before applying sheet finishing. For example, JP 2011-27955A discloses an apparatus for moisturizing a sheet, which includes a pair of moisturizing rollers capable of retaining water in its outer peripheral surfaces and applies water to the overall surface of the sheet while the sheet is being pinched and conveyed by the pair of moisturizing rollers.

The apparatus described in JP 2011-27995A is intended for correcting a curled sheet, and the amount of water applied is therefore set to a level that does not moisture the sheet too much. If the apparatus is used for reducing the stiffness of a sheet, it is required to increase the amount of water applied to the sheet compared to correcting a curled sheet.

However, the apparatus described in JP 2011-27995A moisturizes the overall surface of a sheet. Accordingly, when the amount of water is increased from the level for correcting a curled sheet, the stiffness of the sheet can be reduced. However, water droplets are formed in the sheet feeding path in the apparatus in the downstream of the pair of moisturizing rollers. The front end of the subsequent sheet may cling to the sheet conveyance path. Further, metal parts may rust.

### SUMMARY OF THE INVENTION

The present invention was made in view of the above-described problems with the prior art, and an object thereof is to provide a sheet moisturizing apparatus and an image forming system that can prevent failures of the apparatus relating to sheet finishing and negative influences of the moisture on the apparatus.

In order to realize the above object, according to a first aspect of the present invention, there is provided a sheet moisturizing apparatus, including: a moisturizing section comprising a pair of moisturizing rollers that moisturizes a sheet and a driver that rotates the pair of moisturizing rollers; a water feeding section that feeds water to an outer peripheral surface of the pair of moisturizing rollers; and a control section that controls the water feeding section to feed water only to a predetermined part of the outer peripheral surface of at least one of the pair of moisturizing rollers or controls the water feeding section to feed water to at least one of the pair of moisturizing rollers such that a predetermined part of the outer peripheral surface is fed with water in a greater amount than a remaining part, and thereafter allows the rotating pair of moisturizing rollers driven by the driver to pinch the sheet so as to bring the predetermined part into contact with a sheet finishing area of the sheet to which sheet finishing is applied.

Preferably, in the sheet moisturizing apparatus, the predetermined part of the outer peripheral surface of the pair of moisturizing rollers and the sheet finishing area of the sheet have a same length in a sheet conveying direction.

Preferably, in the sheet moisturizing apparatus, when a front end in the sheet conveying direction of the sheet finishing area of the sheet reaches a nip portion of the pair of moisturizing rollers, the control section controls the driver to decrease a rotation speed of the pair of moisturizing rollers.

Preferably, in the sheet moisturizing apparatus, when a center part in the sheet conveying direction of the sheet finishing area of the sheet reaches a nip portion of the pair of moisturizing rollers, the control section controls the driver to stop rotation of the pair of moisturizing rollers for a predetermined period of time.

Preferably, in the sheet moisturizing apparatus, the moisturizing section comprises a conveying member that conveys the sheet, the predetermined part of the outer peripheral surface of the pair of moisturizing rollers has a length in the sheet conveying direction greater than the sheet finishing area of the sheet, and, when a front end in a sheet conveying direction of the sheet finishing area of the sheet reaches a nip portion of the pair of moisturizing rollers, the control section controls the driver to increase a rotation speed of the pair of moisturizing rollers such that a surface speed of the pair of moisturizing rollers is greater than a sheet conveying speed of the conveying member.

Preferably, in the sheet moisturizing apparatus, the control section controls the water feeding section to feed water only to one of the pair of moisturizing rollers according to a type of the sheet.

Preferably, in the sheet moisturizing apparatus, the moisturizing section further comprises a conveying member that conveys the sheet, the remaining part of the outer peripheral surface of the pair of moisturizing rollers has a length in a sheet conveying direction shorter than an area of the sheet to which a less amount of water is applied compared to the sheet finishing area, and, when a front end in the sheet conveying direction of the area of the sheet to which a less amount of water is applied compared to the sheet finishing area reaches a nip portion of the pair of moisturizing rollers, the control section controls the driver to decrease a rotation speed of the pair of moisturizing rollers such that a surface speed of the pair of moisturizing rollers is less than a sheet conveying speed of the conveying member.

According to a second aspect of the present invention, there is provided an image forming system, including: an image forming apparatus that forms an image on a sheet; and the sheet moisturizing apparatus according to claim 1, which moisturizes the sheet on which the image has been formed by the image forming apparatus.

Preferably, the image forming system further includes a sheet finishing apparatus that applies sheet finishing to the sheet.

According to a third aspect of the present invention, there is provided a sheet moisturizing apparatus, including: a moisturizing section comprising a pair of moisturizing rollers that moisturizes a sheet and a driver that rotates the pair of moisturizing rollers; a water feeding section that feeds water to an outer peripheral surface of the pair of moisturizing rollers; an information acquiring section that acquires information on sheet finishing to be applied to the sheet; an application area determining section that determines a water application area of the sheet to which water is applied based on the information acquired by the information acquiring section; a water feed control section that controls the water feeding section to feed water only to a predetermined part of the outer peripheral surface of at least one of the pair of moisturizing rollers based on the area determined by the application area determining section; and an application control section that allows the rotating pair of moisturizing rollers driven by the driver to pinch the sheet so as to bring the predetermined part into contact with a sheet finishing area of the sheet after water is fed by the water feed control section.

### BRIEF DESCRIPTION OF THE DRAWINGS

The present invention will become more fully understood from the detailed description given hereinbelow and the appended drawings which are given by way of illustration only, and thus are not intended as a definition of the limits of the present invention, and wherein:

FIG. 1 is a schematic diagram of an image forming system, illustrating the overall configuration thereof;

FIG. 2 is a block diagram illustrating the major configuration of the control of an image forming system;

FIG. 3 illustrates the major configuration of a first sheet finishing apparatus;

FIG. 4 is an enlarged view of a major part of a moisturizing section, illustrating the configuration thereof;

FIG. 5 is an example of a table of moisturizing condition;

FIG. 6 illustrates an example of a sheet finishing area;

FIG. 7 illustrates an example of a water application area of a moisturizing roller;

FIG. 8 is a flowchart illustrating the process of moisturizing according to a first embodiment;

FIG. 9A is a schematic view to describe the action of a pair of moisturizing rollers and water feeding rollers in moisturizing;

FIG. 9B is a schematic view to describe the action of a pair of moisturizing rollers and water feeding rollers in moisturizing;

FIG. 9C is a schematic view to describe the action of a pair of moisturizing rollers and water feeding rollers in moisturizing;

FIG. 10A is a schematic view to describe the action of a pair of moisturizing rollers and water feeding rollers in moisturizing;

FIG. 10B is a schematic view to describe the action of a pair of moisturizing rollers and water feeding rollers in moisturizing;

FIG. 11 is a flowchart illustrating the process of moisturizing according to Variation 1;

FIG. 12 is a flowchart illustrating the process of moisturizing according to Variation 2;

FIG. 13 illustrates an example of the relationship between stop time of a pair of moisturizing rollers and basis weight of a sheet in moisturizing according to Variation 2;

FIG. 14 is an example of a table of moisturizing condition according to Variation 3;

FIG. 15 is a flowchart illustrating the process of moisturizing according to Variation 3;

FIG. 16 is a flowchart illustrating the process of moisturizing according to a second embodiment;

FIG. 17 is a flowchart illustrating an example of the process of moisturizing in which the remaining area other than the sheet finishing area is moisturized with a less amount of water than the amount of water applied to the sheet finishing area;

FIG. 18A illustrates the condition of a sheet during the operation of FIG. 17; and

FIG. 18B is a graph illustrating the relationship between location in the sheet of FIG. 18A in the conveying direction and amount of water applied.

### DETAILED DESCRIPTION OF THE PREFERRED EMBODIMENT

Hereinafter, an embodiment of the present invention will be described with reference to the drawings. Though various technical limitations which are preferable to perform the present invention are included in the after-mentioned embodiment, the scope of the invention is not limited to the following embodiment and the illustrated examples.

### First Embodiment

### Image Forming System

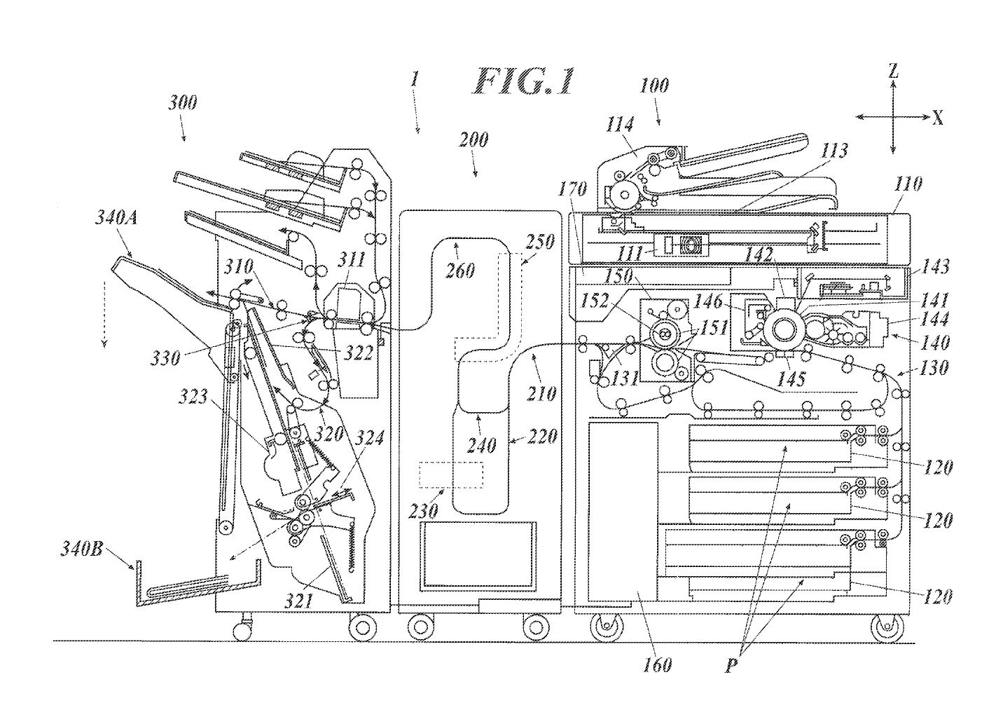

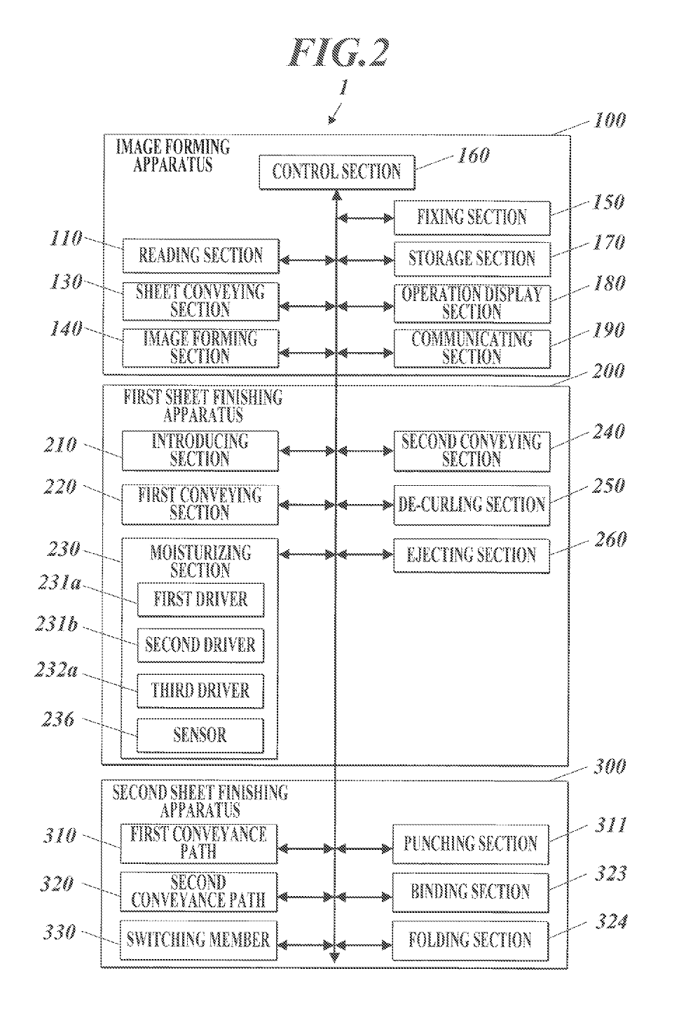

FIG. 1 is a schematic diagram of an image forming system 1, illustrating the overall configuration thereof. FIG. 2 is a block diagram illustrating the major configuration of the control of an image forming system 1.

As illustrated in FIG. 1 and FIG. 2, the image forming system 1 includes an image forming apparatus 100, a first sheet finishing apparatus 200 and a second sheet finishing apparatus 300.

The image forming apparatus 100 forms an image on a sheet P.

The first sheet finishing apparatus 200 is a sheet moisturizing apparatus that performs moisturizing so as to moisturize the sheet P on which an image has been formed by the image forming apparatus 100.

The second sheet finishing apparatus 300 applies punching, binding and folding to the sheet P on which an image has been formed by the image forming apparatus 100.

In the following description, X-direction refers to the direction in which the image forming apparatus 100, the first sheet finishing apparatus 200 and the second sheet finishing apparatus 300 are coupled to each other, Z-direction refers to the vertical direction, and Y-direction refers to the direction perpendicular to X-direction and Z-direction.

### Image Forming Apparatus

First, the image forming apparatus 100 will be described.

As illustrated in FIG. 1 and FIG. 2, the image forming apparatus 100 includes, for example, a reading section 110, a paper feeding tray 120, a sheet conveying section 130, an image forming section 140, a fixing section 150, a control section 160, a storage section 170, an operation display section 180, a communicating section 190 and the like.

The reading section 110 optically reads an original to generate image data.

Specifically, the reading section 110 includes, for example, a sensor section 111 with an imaging element such as a CCD (charge coupled device) image sensor or a CMOS (complementary metal oxide semiconductor) image sensor to output an electric signal corresponding to an read image, a generating section (not shown) that generates the image data based on the electric signal output from the sensor section 111, a document table 113 that includes an optically permeable plate member disposed at the image reading side of the sensor section 111 so that an original can be mounted on the plate member, an auto document feeder (ADF) 114 that conveys an original to move it relative to the sensor section 111, and the like. The sensor section 111 reads an original mounted on the document table 113. The sensor section 111 also reads an original conveyed by the auto document feeder 114.

The paper feeding tray 120 is a box member that is disposed in a switchable manner between a housed position and a pull-out position with respect to the housing of the image forming apparatus 100 and is capable of storing the sheet P. The paper feeding tray 120 stores the sheet P on which an image has not been formed by the image forming apparatus 100 yet. As illustrated in FIG. 1, a plurality of paper feeding trays 120 are provided so that each tray can store the sheet P with a different size. The plurality of paper feeding trays 120 may store the sheets P with the same size.

The sheet conveying section 130 conveys the sheet P between sections including the paper feeding tray 120, the image forming section 130, the image forming section 140 and the fixing section 150.

Specifically, the sheet conveying section 130 includes, for example, a plurality of rollers disposed intermittently along a predetermined sheet conveyance path between sections such as the paper feeding tray 120, the image forming section 130, the image forming section 140 and the fixing section 150 as well as around the sections, a driving section (not shown) to drive the rollers, and the like. The sheet conveying section 130 pulls out the sheet P stored in the paper feeding tray 120 one by one and conveys it to the image forming section 140. After an image is formed on the sheet P by the image forming section 140, the sheet conveying section 130 conveys the sheet P to the fixing section 150. Then, after the image is fixed by the fixing section 150, the sheet conveying section 130 conveys the sheet P to eject it from a sheet eject opening disposed at the side facing the first sheet finishing apparatus 200. In the case of double-sided printing, the sheet conveying section 130 flips the sheet P and returns it to the image forming section 140 through a branch point 131 disposed in the conveyance path between the fixing section 150 and the paper eject opening.

The image forming section 140 forms an image on the sheet P.

Specifically, the image forming section 140 includes, for example, a photoreceptor 141 disposed such that its outer peripheral surface comes in contact with the sheet P conveyed from the sheet conveying section 130, a charging section 142 that charges the photoreceptor 141, an exposing section 143 that exposes the charged photoreceptor 141 according to the image data, a developing section 144 that forms a toner image corresponding to the image data and transfers it to the photoreceptor 141 (primary transfer), a transferring section 145 that transfers the transferred toner image on the photoreceptor 141 to the sheet P (secondary transfer), a cleaning section 146 that removes a residual toner on the photoreceptor 141 from the photoreceptor 141, and the like. The image forming section 140 according to this embodiment forms an image by an electrophotographic method using the above-described configuration. However, it is merely an example, and the present invention is not limited thereto. For example, the image forming section 140 may has a configuration for forming an image by another image forming method such as an ink-jet method.

Further, the image forming section 140 as illustrated in FIG. 1 includes one developing section 144 to form a monochromatic image. However, it is merely an example, and the present invention is not limited thereto. For example, the image forming section 140 may include developing sections 144 respectively for cyan (C), magenta (M), yellow (Y) and black (K) so that it can print a color image composed of a combination of these colors.

The fixing section 150 fixes the image that is formed on the sheet P by the image forming section 140.

Specifically, the fixing section 150 includes, for example, a pair of fixing rollers 151, 151 disposed such that the outer peripheral surfaces abut each other across the conveyance path of the sheet P, a heating section 152 that heats one of the fixing rollers 151, 151 (e.g. the upper roller in FIG. 1) that is located at the side of the sheet P on which an image is formed by the image forming section 140, and the like. The fixing section 150 fixes the toner image transferred on the sheet P by pinching the sheet P with the rotating pair of fixing rollers 151, 151 and heating the sheet P with the image with one of the rollers heated by the heating section 152 while conveying it.

The control section 160 integrally controls the apparatuses of the image forming system 1 or the sections of the apparatuses according to a command from the operation display section 180 or the communicating section 190. The control section 160 includes a CPU (central processing unit), a RAM (random access memory) and the like. The CPU reads a program stored in the storage section 170 and develops it to a work area in the RAM, so as to execute various processing in cooperation with the program.

For example, the control section 160 controls the image forming apparatus 100 to form an image on the sheet P based on the image data acquired by the reading section 110.

Further, the control section 160 controls the first sheet finishing apparatus 200 to moisturize the sheet P according to a preset moisturizing condition. To be more specific, the control section 160 acquires information on the sheet finishing to be applied to the sheet (information acquiring section), determines the area of the sheet to which water is applied based on the information acquired by the information acquiring section (application area determining section), and controls water feeding rollers 232, 232 to feed water to a predetermined part of the outer peripheral surface of at least one of a pair of moisturizing rollers 231, 231 based on the area determined by the application area determining section (water feed control section). After water is fed by the control of the water feed control section, the control section 160 allows the rotating pair of moisturizing rollers 231, 231, which are driven by a first driver 231a, to pinch the sheet so as to bring the predetermined part into contact with the area of the sheet to which the sheet finishing is applied (application control section).

Further, the control section 160 controls the second sheet finishing apparatus 300 to apply sheet finishing to the sheet P according to a preset condition.

In this embodiment, as described below with FIG. 2, the image forming apparatus 100 includes the control section 160 that integrally controls the whole image forming system 1. Instead, the image forming apparatus 100, the first sheet finishing apparatus 200 and the second sheet finishing apparatus 300 may include respective own control sections that control the respective apparatuses and communicate with other apparatuses.

The storage section 170 stores a program executed by the control section 160 and data required to execute the program.

For example, the storage section 170 stores the moisturizing condition, which is used for controlling a moisturizing section 230 of the first sheet finishing apparatus 200. When the moisturizing condition is set according to a user input on the operation display section 180, the storage section 170 stores the set moisturizing condition. Details of the moisturizing condition will be described below.

In addition, the storage section 170 stores, for example, a condition of the sheet finishing by the second sheet finishing apparatus 300, and the like.

The operation display section 180 displays a variety of information on the operation of the image forming system 1. Furthermore, the operation display section 180 includes a touch panel that detects various user inputs, which are made according to the displayed screen, a plurality of switches for various user inputs, and the like. The control section 160 performs processing for controlling the screen displayed on the touch panel of the operation display section 180. Further, the control section 160 controls the image forming system 1 based on the variety of user inputs made on the operation display section 180.

The operation display section 180 is used, for example, for inputting the moisturizing condition for the operation of the moisturizing section 230 of the first sheet finishing apparatus 200.

The communicating section 190 includes a network interface card (NIC) or an equivalent component. The communicating section 190 performs communication between the image forming system 1 and other computers. When a print job containing image data is input through the communicating section 190, the control section 160 performs an image formation or the like based on the print job.

The sheet P ejected from the image forming apparatus 100 as described above is then conveyed to the first sheet finishing apparatus 200.

### First Sheet Finishing Apparatus

Next, the first sheet finishing apparatus 200 will be described.

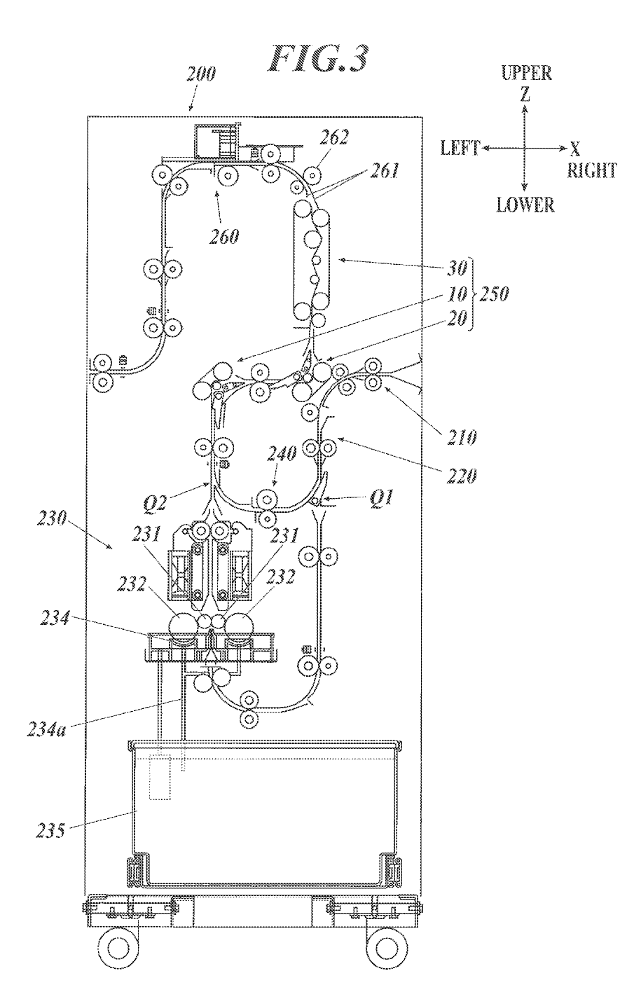

FIG. 3 illustrates the major configuration of the first sheet finishing apparatus 200.

As illustrated in FIG. 2 and FIG. 3, the first sheet finishing apparatus 200 includes, for example, an introducing section 210, a first conveying section 220, a moisturizing section 230, a second conveying section 240, a de-curling section 250, an ejecting section 260 and the like.

In the following description, the term “right side” or “left side” is used with respect to the X-direction, and the term “upper side” or “lower side” is used with respect to the Z-direction. The right side corresponds to the side of the first sheet finishing apparatus 200 that faces the image forming apparatus 100, and the left side corresponds to the side of the first sheet finishing apparatus 200 that faces the second sheet finishing apparatus 300. The upper side corresponds to the side where the ejecting section 260 is located in the first sheet finishing apparatus 200, and the lower side corresponds to the side where the moisturizing section 230 is located in the first sheet finishing apparatus 200.

The introducing section 210 receives the sheet P ejected from the image forming apparatus 100 into the first sheet finishing apparatus 200.

The first sheet conveying section 220 conveys the sheet P, which has been received in the first sheet finishing apparatus 200 by the introducing section 210, to the moisturizing section 230 disposed below the introducing section 210. The first conveying section 220 includes a branch point Q1 provided in the midway thereof, which is a branch point of a conveyance path that leads the sheet P to the second conveying section 240.

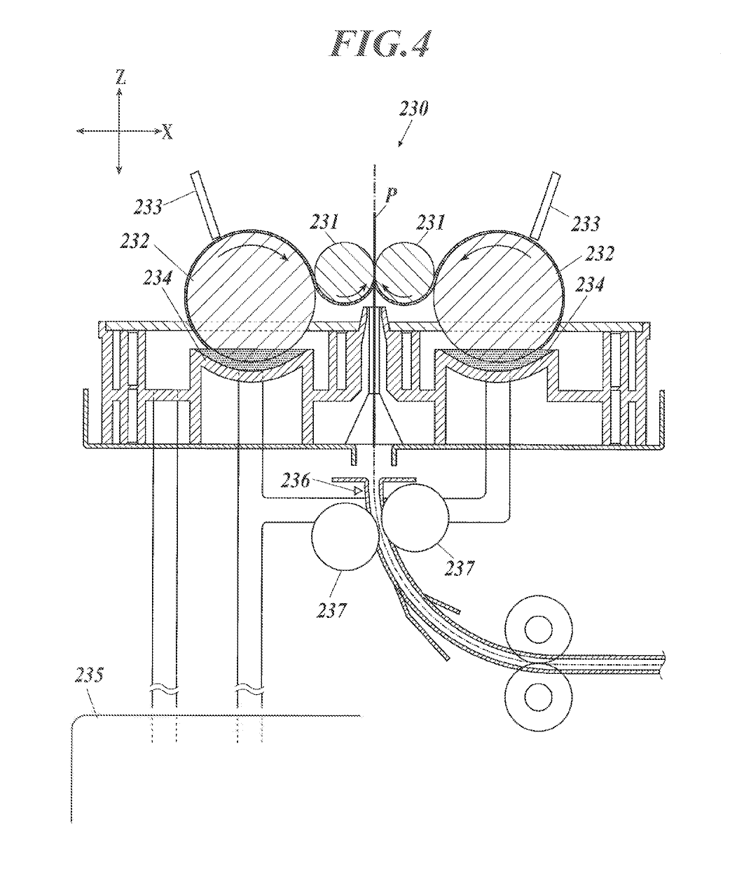

FIG. 4 is an enlarged view of the major part of the moisturizing section 230, illustrating the configuration thereof.

The moisturizing section 230 is configured to moisturize the sheet P that is conveyed from the first conveying section 220. The moisturizing section 230 includes, for example, the pair of moisturizing rollers 231, 231, the water feeding rollers 232, 232 that feed water to the pair of moisturizing rollers 231, 231 respectively, blade sections 233, 233 that removes excessive water on the pair of moisturizing rollers 231, 231, water reservoir sections 234 that retain water to be fed to the water feeding rollers 232, 232, a tank 235 that stores water, a sensor 236 disposed in the upstream of the pair of moisturizing roller 231, 231, conveying rollers 237, 237 that convey the sheet to the pair of moisturizing rollers 231, 231, and the like.

The pair of moisturizing rollers 231, 231 is disposed such that the longitudinal axes are parallel to the width direction of the sheet P, and the outer peripheral surfaces are in contact with each other. The pair of moisturizing rollers 231, 231 rotates by being driven by a first driver 231a (see FIG. 2), so as to pinch and convey the sheet. In this embodiment, the conveying speed of the sheet is controlled at a constant speed.

The pair of moisturizing rollers 231, 231 is configured such that the outer peripheral surfaces can retain water. The pair of moisturizing rollers 231, 231 is made of hydrophilic rubber capable of retaining water, or the like. For example, acrylonitrile, butadiene rubber (NBR) and the like can be suitably used.

When the pair of moisturizing rollers 231, 231 rotates and pinches the sheet P with the part retaining water, it moisturizes the sheet P while conveying it to the downstream. When the pair of moisturizing rollers 231, 231 rotates and pinches the sheet P with the part not retaining water, it simply functions as normal conveying rollers to convey the sheet P to the downstream.

Further, the pair of moisturizing rollers 231, 231 is configured to be movable in the direction of abutting or separating from each other by being driven by a second driver 231b (see FIG. 2). This configuration allows changing the pressure of pinching the sheet. In this embodiment, the distance between the pair of moisturizing rollers 231, 231 (the pressure of pinching the sheet) is controlled to keep a constant value.

The water feeding rollers (water feeding section) 232, 232, which are provided for the respective moisturizing rollers 231, 231, are configured to rotate in contact with the outer peripheral surfaces of the moisturizing rollers 231 and with the water reserved in the reservoir section 234, so as to take water of the reservoir section 234 in the outer peripheral surfaces to transfer it to the moisturizing rollers 231.

The water feeding rollers 232, 232 are configured to be movable in the direction of abutting or separating from the pair of moisturizing rollers 231, 231 by being driven by a third driver 232a (see FIG. 2).

The blades 233, 233 are disposed over the pair of moisturizing rollers 231, 231 so that they can contact with the outer peripheral surfaces of the pair of moisturizing rollers 231, 231. When the pair of moisturizing rollers 231, 231 rotates, the blades 233, 233 can remove excessive water retained on the outer peripheral surfaces of the pair of moisturizing rollers 231, 231 by rubbing the outer peripheral surfaces.

The reservoir sections 234 have arc-shaped bottoms along the arc of the outer peripheral surfaces of the water feeding rollers 232, 232, and water is reserved on the arc-shaped bottoms. Each of the outer peripheral surfaces of the water feeding rollers 232 is located below the surface of the water reserved in the reservoir sections 234 but is not in contact with the arc-shaped bottoms of the reservoir sections 234. Accordingly, as the water feeding rollers 232 rotate, the outer peripheral surfaces are covered by water reserved in the reservoir sections 234. The reservoir sections 234 are connected to the tank 235 disposed therebelow via a delivery path 234a.

The tank 235 is a container for storing water therein. The water in the tank 235 is fed to the reservoir sections 234 via the delivery path 234a by the action of a pump (not shown). This allows maintaining the amount of water reserved in the reservoir sections 234 at a suitable level.

The sensor 236 is disposed at a predetermined position in the upstream of the nip portion of the pair of moisturizing rollers 231, 231 in the conveying direction of the sheet P. When the sensor 236 detects that the sheet P is conveyed to the predetermined position, it outputs a detection signal to the control section 160.

The conveying rollers 237, 237 are rotated by a driving motor (not shown) to convey the sheet P to the pair of moisturizing rollers 231, 231.

The rotation speed of the conveying rollers 237, 237 is the same as that of the pair of moisturizing rollers 231, 231. Further, the pressure of the conveying rollers 237, 237 on the pinched sheet P is set to the same level as that of the pair of moisturizing rollers 231, 231.

In this embodiment, the moisturizing section 230 performs the moisturizing according to the moisturizing condition by the control of the control section 160. Details of the moisturizing will be described below.

Back to FIG. 3, the second conveying section 240 conveys the sheet P, which was received in the first sheet finishing apparatus 200 through an introducing section 210, to the downstream of the moisturizing section 230 without passing the sheet P through the moisturizing section 230. That is, the second conveying section 240 conveys the sheet P, which was not sent to the moisturizing section 230 but was branched at the branch point Q1 of the first conveying section 220, to the junction Q2 disposed at the downstream of the moisturizing section 230.

The de-curling section 250 is a mechanism for correcting the curled sheet P while conveying it. The de-curling section 250 includes a first de-curling section 10, a second de-curling section 20 and a third de-curling section 30.

The first de-curling section 10 and the second de-curling section 20 are provided to correct large curling of the sheet P. The first de-curling section 10 conveys the sheet P from the lower side to the right side, and the second de-curling section 20 conveys the sheet P from the right side to the upper side.

The third de-curling section 30 is provided to correct small curling of the sheet P. The third de-curling section 30 applies a pinching force on the sheet P alternately from the right and left sides while conveying the sheet P upward.

The ejecting section 260 includes a curved conveying section which receives the sheet P sent from the third de-curling section 30 of the de-curling section 250 and which conveys it downward and then leftward. Through the curved conveying section, the ejecting section 260 conveys the sheet P to the second sheet finishing apparatus 300.

As described above, in the first sheet finishing apparatus 200, a winding conveyance path is formed from the introducing section 210 to the ejecting section 260. Such a winding path is provided to prevent the curves of the path from being dominant in a certain direction, so as to prevent the sheet P from being curled to a certain side.

Next, the moisturizing performed in the moisturizing section 230 of the first sheet finishing apparatus 200 will be described.

The moisturizing of this embodiment is performed according to a preset moisturizing condition, in which the sheet P is moisturized (water is applied) only within the sheet finishing area.

The moisturizing condition defines a water application area (A) of the pair of moisturizing rollers 231, 231 and a water application area (B) of the sheet P according to the job information.

As used herein, the water application area (A) of the pair of moisturizing rollers 231, 231 refers to the area in the outer peripheral surfaces of the pair of moisturizing rollers 231, 231 with a certain length in the circumferential direction to which water is applied by the water feeding rollers (water feeding sections) 232, 232. The water application area (B) of the sheet P refers to the area of the sheet P to which sheet finishing is applied, specifically the area of the sheet P with a certain length in the sheet conveying direction to which sheet finishing is applied.

FIG. 5 is an example of the table of moisturizing condition.

In FIG. 5, type of sheet P includes plain paper, board paper (e.g. sheet with a basis weight of 100 g/m² or more) and coated cardboard, and type of sheet finishing includes punching, binding and folding. The table defines the water application area (A) of the pair of moisturizing rollers 231, 231 and the water application area (B) of the sheet P with respect to each of their combinations. In the case of plain paper, the moisturizing is performed when the job includes 10 sheets or more.

For example, the moisturizing condition is set as follows. In the following example, a moisturizing condition for folding a board paper is described.

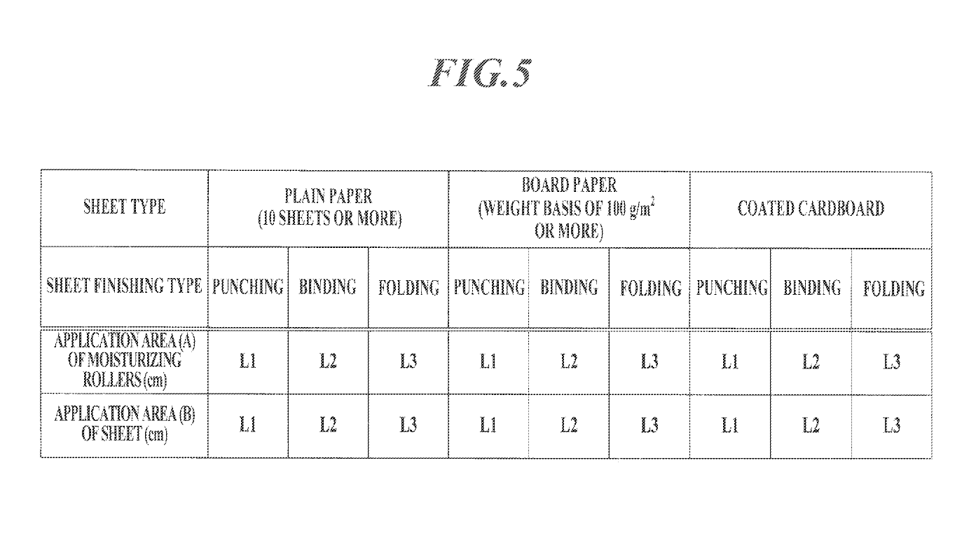

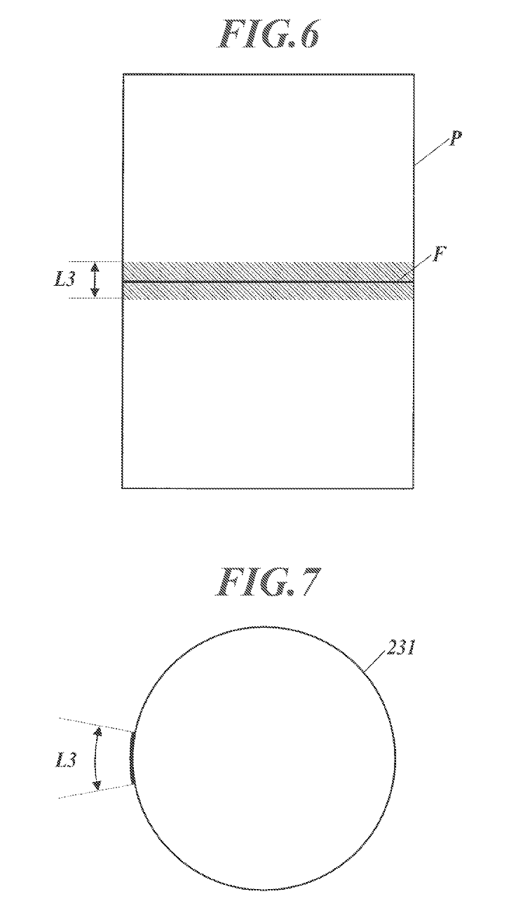

The folding (center folding) is performed such that the sheet P is folded along the folding line F at the center in the longitudinal direction as illustrated by the bold line F in FIG. 6. In this example, the area around the folding line F corresponds to the sheet finishing area (B) of the sheet P. That is, it is desirable to apply water to the area around the folding line F in order to reduce the stiffness of the sheet P to reduce the load on the sheet finishing mechanism for the folding process. The sheet finishing area (B) of the sheet P may cover only the folding line F or have a predetermined length in the longitudinal direction with respect to the folding line F. In this case, the sheet finishing area (B) of the sheet P has a length L3.

In this embodiment, the water application area (A) of the pair of moisturizing rollers 231, 231 and the water application area (B) of the sheet P are set to have the same length according to the combination of the type of sheet P and the type of sheet finishing.

That is, the water application area (A) of the pair of moisturizing rollers 231, 231 is set to have the length L3. More specifically, as illustrated in FIG. 7, the area with the length L3 in the outer peripheral surface of the pair of moisturizing rollers 231, 231 is set as the water application area (A) of the pair of the moisturizing rollers 231, 231. The location of the water application area (A) of the pair of moisturizing rollers 231, 231 among the outer peripheral surfaces of the pair of moisturizing rollers 231, 231 is set such that water can be applied to the sheet finishing area (B) of the sheet P.

As described above, the moisturizing condition is set according to the contents of a job, e.g. the type of sheet, the number of sheet(s) and the type of sheet finishing.

In FIG. 5, a single application area is defined for punching, binding or folding. Instead, a more detailed moisturizing condition may be defined according to the specific contents of sheet finishing applied to a sheet. For example, in the case of three-folding, which folds a sheet in three, two application areas may be set corresponding to the two folding lines respectively.

Further, the application area (B) for folding a predetermined number or more of sheets may be larger than the application area (B) for folding less than a predetermined number of sheets.

If the moisturizing condition is not met, i.e. neither water application area (A) of the pair of moisturizing rollers 231, 231 nor the water application area (B) of the sheet P is defined for the combination of the type of the sheet P to which sheet finishing is applied and the type of sheet finishing, no moisturizing is performed.

When a job starts, the control section 160 makes a determination as to whether the moisturizing is performed based on the job information and the moisturizing condition and also determines the water application area (A) of the pair of moisturizing rollers 231, 231 and the water application area (B) of the sheet P.

Then, the control section 160 controls the third driver 232a to bring the water feeding rollers 232, 232, which retain water in the outer peripheral surfaces thereof, into contact with the rotating pair of moisturizing rollers 231, 231 at a predetermined timing for a predetermined period of time, so as to apply water to the water application area (A) of the pair of moisturizing rollers 231, 231.

Further, the control section 160 rotates the pair of moisturizing rollers 231, 231 and the conveying rollers 237, 237 at a predetermined constant speed, so as to convey the sheet P from the lower side to the upper side at the predetermined constant conveying speed. The control section 160 thus allows the pair of moisturizing rollers 231, 231 to pinch and convey the sheet P so as to apply water to the water application area (B) of the sheet P.

FIG. 8 is a flowchart illustrating the process of the above-described moisturizing in the moisturizing section 230.

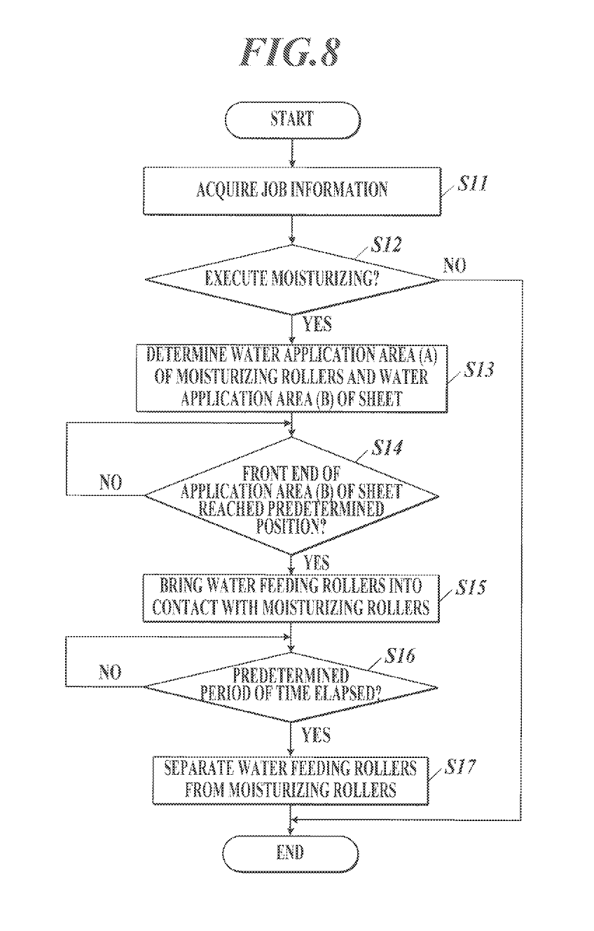

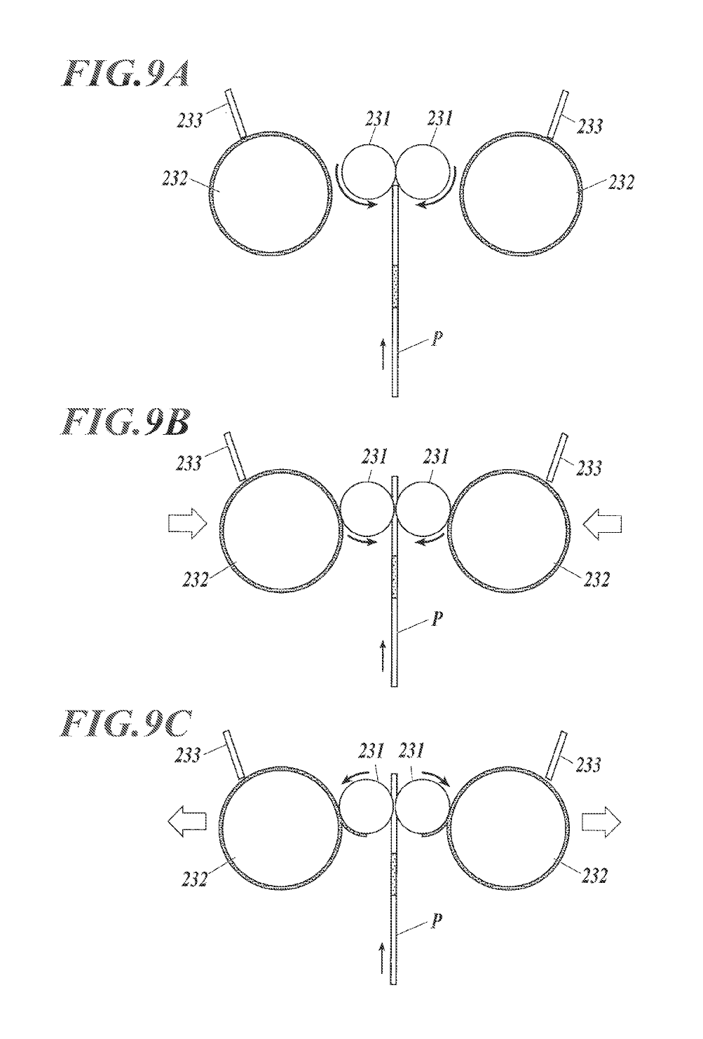

During the process, the pair of moisturizing rollers 231, 231 is rotated at a predetermined constant speed by the first driver 231a as illustrated in FIG. 9A. Further, the sheet P is conveyed from the lower side to the upper side at the constant conveying speed.

First, the control section 160 acquires the job information (Step S11).

Specifically, it acquires the type and the number of the sheet P and the type of sheet finishing to be applied to the sheet P (information acquiring section).

In this case, folding is applied to a board paper as an example. The control section 160 may determine the sheet type as board paper based on either sheet type information or basis weight information included in the input job information.

Then, the control section 160 refers to the moisturizing condition stored in the storage section 170 to make a determination as to whether to perform the moisturizing according to the acquired job information (Step S12).

Specifically, the control section 160 refers to the moisturizing condition stored in the storage section 170 to make a determination as to whether the acquired job information meets any of the combinations of the moisturizing condition. If any of the combinations is met, it determines to perform the moisturizing. If none of the combinations is met, it determines not to perform the moisturizing. Since folding is applied to a board paper in this case, it is determined to perform the moisturizing based on the moisturizing condition of FIG. 5.

If it is determined not to perform the moisturizing (Step S12, No), the control section 160 terminates the process.

If it is determined to perform the moisturizing (Step S12, Yes), the control section 160 determines the water application area (A) of the pair of moisturizing rollers 231, 231 and the water application area (B) of the sheet P (Step S13).

Specifically, the control section 160 refers to the moisturizing condition stored in the storage section 170 to determine the water application area (A) of the pair of moisturizing rollers 231, 231 and the water application area (B) of the sheet P according to a combination in the moisturizing condition that meets the acquired job information (application area determining section).

As described above, the moisturizing condition is defined such that the water application area (A) of the pair of moisturizing rollers 231, 231 and the water application area (B) of the sheet P have the same length.

Accordingly, in this case, both of the water application area (A) of the pair of moisturizing rollers 231, 231 and the water application area (B) of the sheet P are set to have the length L3.

Then, the control section 160 makes a determination as to whether the front end of the water application area (B) of the sheet P reaches a predetermined position in the upstream of the nip portion of the pair of moisturizing rollers 231, 231 (Step S14).

Specifically, the control section 160 makes a determination as to whether the front end of the water application area (B) of the sheet P reaches the predetermined position based on the elapsed time since it receives a detection signal output from the sensor 236 and the conveying speed of the sheet P.

If the front end of the water application area (B) of the sheet P has not reached the predetermined position (Step S14, No), the control section 160 repeats Step S14.

If the front end of the water application area (B) of the sheet P has reached the predetermined position (Step S14, Yes), the control section 160 drives the third driver 232a to bring the water feeding rollers 232, 232 into contact with the pair of moisturizing rollers 231, 231 (water feed control section, Step S15).

By this step, water starts to be fed from the water feeding rollers 232, 232 to the pair of moisturizing rollers 231, 231 (see FIG. 9B).

Then, the control section 160 makes a determination as to whether a predetermined period of time has elapsed (Step S16). If the control section 160 determines the predetermined period of time has not elapsed yet (Step S16, No), it repeats Step S16.

If the control section 160 determines that the predetermined period of time has elapsed (Step S16, Yes), it separates the water feeding rollers 232, 232 from the pair of moisturizing rollers 231, 231 (Step S17).

The predetermined period of time, which corresponds to the period of time required to feed water to the overall water application area (A) of the pair of moisturizing rollers 231, 231, is calculated beforehand from the length of the water application area (A) and the rotation speed of the pair of moisturizing rollers 231, 231.

By this step, water is applied to the predetermined water application area (A) of the pair of moisturizing rollers 231, 231 (see FIG. 9C).

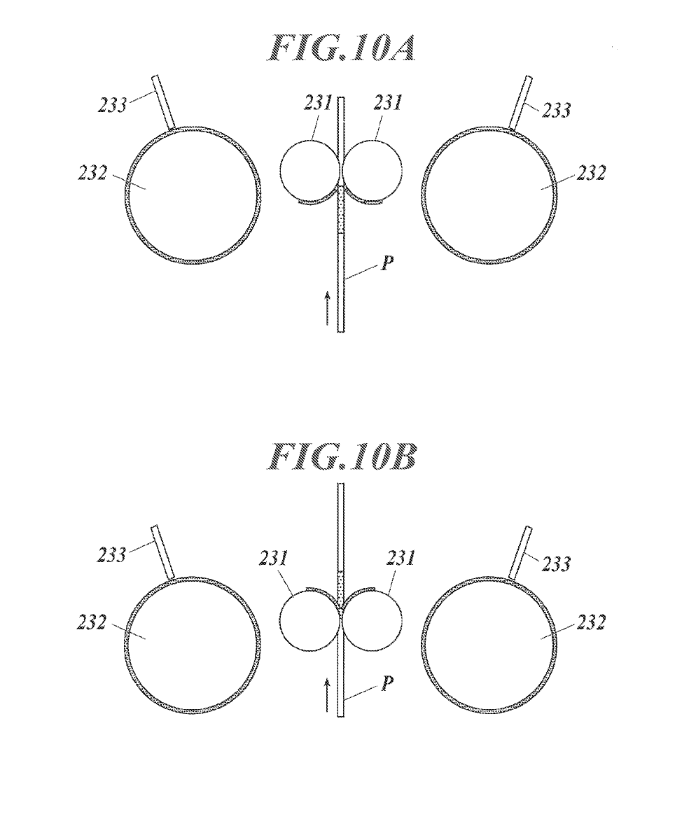

Thereafter, when the front end of the water application area (B) of the sheet P reaches the nip portion of the pair of the moisturizing rollers 231, 231, the water application area (A) of the pair of the moisturizing rollers 231, 231 comes in contact with the sheet P, and water starts to be applied to the sheet P (application control section, see FIG. 10A).

Then, when the rear end of the water application area (B) of the sheet P is released from the nip portion of the pair of moisturizing rollers 231, 231, the application area (A) of the pair of moisturizing rollers 231, 231 is separated from the sheet P. The water application to the sheet P thus ends (see FIG. 10B).

After water is fed to the sheet P, the blades 233, 233 wipe off the water retained in the water application area (A) of the outer peripheral surfaces of the pair of moisturizing rollers 231, 231.

By the above-described moisturizing, the sheet P is processed such that water is applied only to the application area (B), and is then conveyed to the downstream.

### Second Sheet Finishing Apparatus

Back in FIG. 1, the second sheet finishing apparatus 300 includes, for example, a first conveyance path 310, a second conveyance path 320, a switching member 330, sheet eject trays 340A, 340B, and the like. In the first conveyance path 310, for example, a punching section 311 and the like is provided. In the second conveyance path 320, for example, a stacker 321, an aligning member 322, a binding section 323, a folding section 324 and the like are provided.

The first conveyance path 310, which is also referred to as a straight path, includes a plurality of rollers, a driver (not shown) to drive the rollers, and the like. The first conveyance path 310 conveys the sheet P.

The punching section 311, which includes a punching rod, applies punching to the sheet P that has been conveyed from the first sheet finishing apparatus 200, so as to form a punched hole in the sheet P. Below the punching rod, a punch waste bin is provided to collect punch wastes.

In this embodiment, when punching is applied to the sheet P, the sheet P conveyed from the upstream is already moisturized in the area to be punched. Accordingly, even when the sheet P is electrostatically charged before it is conveyed to the first sheet finishing apparatus 200, the water applied to the sheet P neutralizes the charge. This prevents punch wastes from clinging to the sheet due to the electrostatic charge while the punching section 311 performs the punching. As a result, troubles relating to punch waste disposal can be reduced.

When the sheet P is a board paper or a stiff sheet, the load on the punching section 311 during the punching process can be reduced, and noise and vibration can also be reduced.

As with the first conveyance path 310, the second conveyance path 320, which is also referred to as a stack path, includes a plurality of rollers, a driver (not shown) to drive the rollers, and the like. The second conveyance path 320 conveys the sheet P.

The stacker 321 stores the sheet P conveyed to the second conveyance path 320 so as to temporarily stack a plurality of sheets P.

The aligning member 322 is constituted by a pair of width aligning members disposed on both side walls of the stacker 321 in a movable manner. The aligning member 322 is movable in the direction perpendicular to the sheet conveying direction. While the sheet P is being conveyed to the stacker 321, the aligning member 322 is open wider than the sheet width. Then, after the sheet P is conveyed to the stacker 321, the aligning member 322 taps the side edges of the sheet to align it in the width direction. That is, the alignment member 322 aligns a plurality of sheets P in the direction perpendicular to the conveying direction of the sheet P.

The binding section 323, which includes a stapler, binds a bundle of sheets, which is constituted by the plurality of sheets P loaded in the stacker 321, with a staple. The conditions such as number of sheets, binding position (e.g. long side- or short side-binding, or the like), number of binding points are determined according to the setting input on the operation display section 180 of the image forming apparatus 100.

In this embodiment, when the sheets P to be bound are board papers or stiff sheets, the sheets P conveyed from the upstream are already moisturized in the area to be bound. Therefore, the load on the binding section 323 during the binding process can be reduced, and noise and vibration can also be reduced.

The folding section 324 applies folding to the plurality of sheets P stacked in the stacker 321.

In this embodiment, when the sheets P to be folded are board papers or stiff sheets, the sheets P conveyed from the upstream are already moisturized in the area to be folded. Accordingly, the load on the folding section 324 during the folding process can be reduced, and noise and vibration can also be reduced.

A folded bundle of sheets is ejected to the sheet eject tray 340B by a conveying belt (not shown).

The switching member 330 guides the sheet to switch the conveyance path of the sheet between the first conveyance path 310 and the second conveyance path 320. That is, when the switching member 330 is located at a first position, the sheet is conveyed to the first conveyance path 310. When the switching member 330 is located at a second position, the sheet is conveyed to the second conveyance path 320.

The sheet eject tray 340A stacks the sheet ejected from the first conveyance path 310. The sheet eject tray 340B stacks the sheet ejected from the second eject tray 320.

The second sheet finishing apparatus 300 is not limited to the above-described configuration. In addition to the above-described configuration, the second sheet finishing apparatus 300 may further include a configuration for trimming or the like.

As described above, the image forming system 100 according to this embodiment includes: the moisturizing section 230 including the pair of moisturizing rollers 231, 231 that moisturizes the sheet P and the first driver 231a that rotates the pair of moisturizing rollers 231, 231; the water feeding rollers 232, 232 that feeds water to the outer peripheral surface of the pair of moisturizing rollers 231, 231; and the control section 160 that allows the water feeding rollers 232, 232 to feed water to a predetermined part of the outer peripheral surface of the pair of moisturizing rollers 231, 231 and then allows the rotating pair of moisturizing rollers 231, 231, which is driven by the first driver 231a, to pinch the sheet so as to bring the predetermined part into contact with the area of the sheet to which sheet finishing is applied.

Since this configuration enables applying water only in the area to which sheet finishing is applied, the sheet P is not excessively moisturized. This can prevent the front end of the subsequent sheet P from clinging to the sheet conveyance path in the downstream of the pair of moisturizing rollers 231, 231 to cause a paper jam and also prevent the metal parts from rusting, since water droplets are not formed in the sheet feeding path in the apparatus in the downstream of the pair of moisturizing rollers.

Further, since water is applied to the area to which the sheet finishing is applied, the load on the driving system of the sheet finishing mechanism can be reduced when the sheet P to which the sheet finishing is applied is a board paper or a stiff sheet. Also, noise and vibration can be reduced.

Further, since the sheet P is moisturized while it is being pinched and conveyed by the pair of moisturizing rollers 231, 231, it can be uniformly moisturized.

As a result, failures of the apparatus due to the sheet finishing and negative influences of the moisturizing on the apparatus can be prevented.

Further, according to this embodiment, the predetermined part of the outer peripheral surface of the pair of moisturizing rollers 231, 231 has the same length in the sheet conveying direction as the area of the sheet P to which the sheet finishing is applied.

Accordingly, applying water to the water application area (B) of the sheet P can be achieved only by controlling the water feeding rollers 232, 232.

### Variation 1

The above-described embodiment is an example in which the pair of moisturizing rollers 231, 231 rotates at a constant rotation speed during the moisturizing process. Instead, the rotation speed of the pair of moisturizing rollers 231, 231 may be decreased when the front end of the water application area (B) of the sheet P reaches the nip portion of the pair of moisturizing rollers 231, 231.

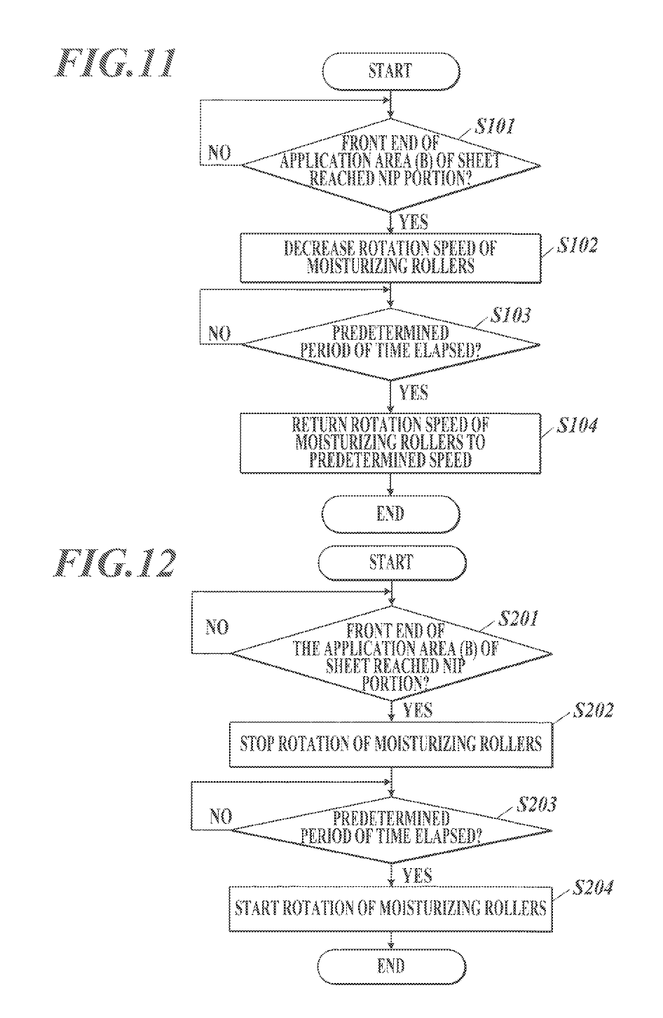

FIG. 11 is a flowchart illustrating the process of moisturizing according to Variation 1.

Before the process illustrated in the flowchart of FIG. 11, Step S11 to Step S17 of FIG. 8 are performed so that water is applied to the water application area (A) of the pair of moisturizing rollers 231, 231.

First, the control section 160 makes a determination as to whether the front end of the water application area (B) of the sheet P reaches the nip portion of the pair of moisturizing rollers 231, 231 (Step S101). If not (Step S101, No), it repeats Step S101.

If the front end of the water application area (B) of the sheet P has reached the nip portion of the pair of moisturizing rollers 231, 231 (Step S101, Yes), the control section 160 controls the first driver 231a to decrease the rotation speed of the pair of moisturizing rollers 231, 231 (Step S102).

Then, the control section 160 makes a determination as to whether a predetermined period of time, which corresponds to the period of time required to pass the water application area (B) of the sheet P through the nip portion of the pair of moisturizing rollers 231, 231, has elapsed (Step S103). If the predetermined period of time has not elapsed (Step S103, No), it repeats Step S103.

If the predetermined period of time has elapsed (Step S103, Yes), the control section 160 controls the first driver 231a to return the rotation speed of the pair of moisturizing rollers 231, 231 to the original rotation speed (Step S104).

This configuration prolongs the period of time while the water feeding rollers 232, 232 are in contact with the pair of moisturizing rollers 231, 231. As a result, the amount of water applied to the sheet P can be increased.

### Variation 2

Alternatively, the apparatus may be configured such that, when the center part of the water application area (B) of the sheet P reaches the nip portion of the pair of moisturizing rollers 231, 231, the rotation of the pair of moisturizing rollers 231, 231 is stopped for a predetermined period of time.

FIG. 12 is a flowchart illustrating the process of moisturizing according to Variation 2.

Before the process illustrated in the flowchart of FIG. 12, Step S11 to Step S17 of FIG. 8 are performed so that water is applied to the water application area (A) of the pair of moisturizing rollers 231, 231.

First, the control section 160 makes a determination as to whether the center part of the water application area (B) of the sheet P reaches the nip portion of the pair of moisturizing rollers 231, 231 (Step S201). If not (Step S201, No), it repeats Step S201.

If the center part of the water application area (B) of the sheet P has reached the nip portion of the pair of moisturizing rollers 231, 231 (Step S201, Yes), the control section 160 controls the first driver 231a to stop the rotation of the pair of moisturizing rollers 231, 231 (Step S202).

The stop time of the pair of moisturizing rollers 231, 231 is preset according to the basis weight of the sheet P.

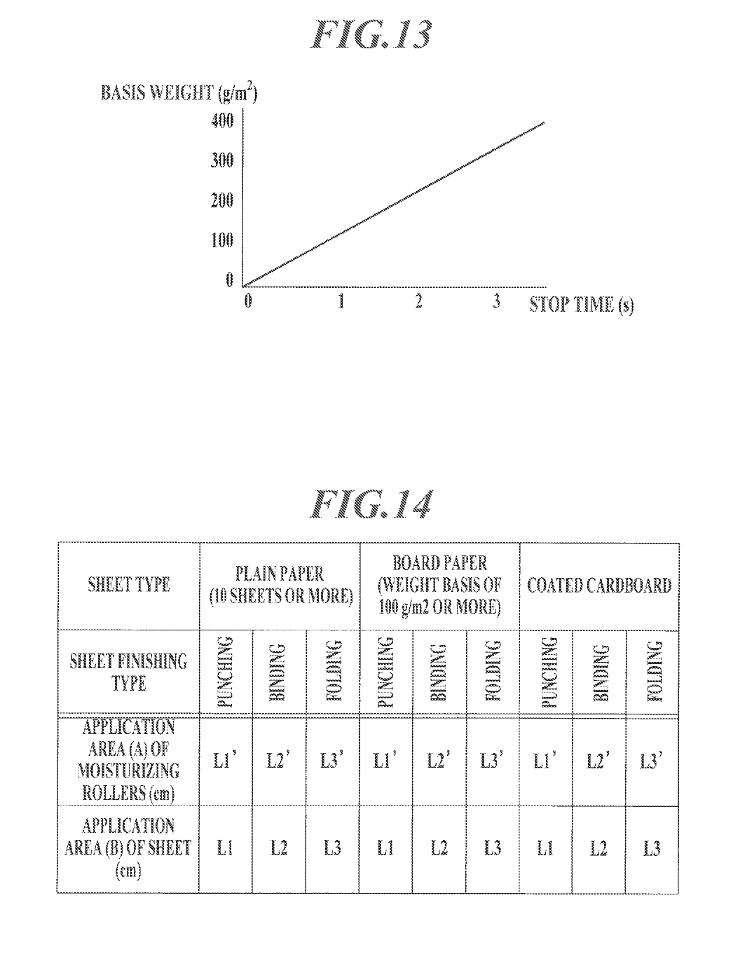

FIG. 13 illustrates an example of the relationship between stop time of the pair of moisturizing rollers 231, 231 and basis weight of the sheet P. As illustrated in FIG. 13, it is preferred that the stop time is increased with an increase of the basis weight.

Then, the control section 160 makes a determination as to whether the stop time has elapsed (Step S203). If not (Step S203), it repeats Step S203. If the stop time has elapsed (Step S203, Yes), the control section 160 controls the first driver 231a to start the rotation of the pair of moisturizing rollers 231, 231 (Step S204).

This configuration allows adequately setting the period of time while the water feeding rollers 232, 232 are in contact with the pair of moisturizing rollers 231, 231 according to the basis weight of the sheet P. As a result, an adequate amount of water can be applied to the sheet P.

It should be understood that the control of Variation 1 and Variation 2 may be combined together.

That is, the apparatus may be controlled such that the rotation speed of the pair of moisturizing rollers 231, 231 is decreased when the front end of the water application area (B) of the sheet P reaches the nip portion of the pair of moisturizing rollers 231, 231, and then the rotation of the moisturizing rollers 231, 231 is stopped when the center part of the water application area (B) of the sheet P reaches the center part of the nip portion of the pair of moisturizing rollers 231, 231.

### Variation 3

In the above-described embodiment, the water application area (A) of the pair of moisturizing rollers 231, 231 and the water application area (B) of the sheet P have the same length. Instead, the length of the water application area (A) of the pair of moisturizing rollers 231, 231 may be set longer than the length of the water application area (B) of the sheet P.

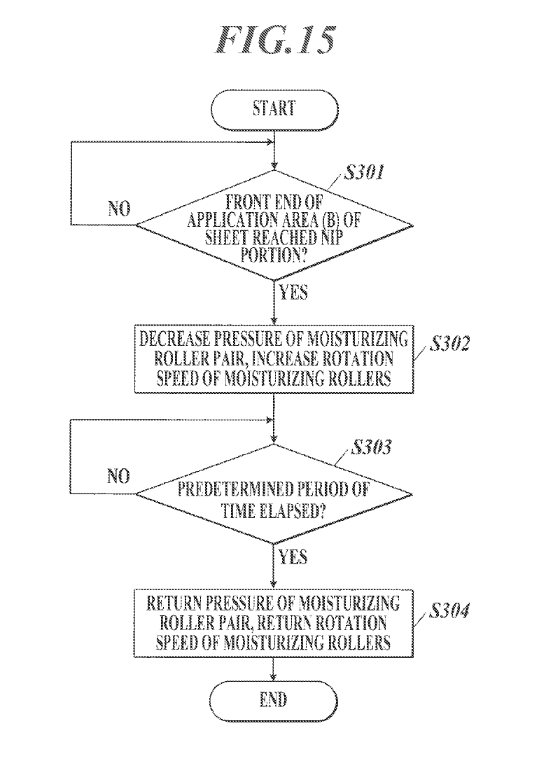

That is, in place of the moisturizing condition of FIG. 5, the moisturizing condition of FIG. 14 is used to perform the moisturizing. The values of the moisturizing condition of FIG. 14 satisfy L1′>L1, L2′>L2 and L3′>L3.

In this case, the control section 160 controls the first driver 231a to increase the rotation speed of the pair of moisturizing rollers 231, 231 such that the surface speed of the pair of moisturizing rollers 231, 231 is greater than the sheet conveying speed of the sheet conveying member (e.g. the conveying rollers 237, 237). That is, the control section 160 controls the pair of moisturizing rollers 231, 231 such that they slip on the surface of the sheet P.

FIG. 15 is a flowchart illustrating the process of moisturizing according to Variation 3. In the process illustrated in FIG. 15, when the front end of the water application area (B) of the sheet P reaches the nip portion of the pair of moisturizing rollers 231, 231, the control section 160 controls the second driver 231b to decrease the pressure of the pair of moisturizing rollers 231, 231 and also controls the first driver 231a to increase the rotation speed of the pair of moisturizing rollers 231, 231.

Before the process illustrated in the flowchart of FIG. 15, Step S11 to Step S17 of FIG. 8 are performed so that water is applied to the water application area (A) of the pair of moisturizing rollers 231, 231. In this variation, the water application area (A) of the pair of moisturizing rollers 231, 231 is set longer than the water application area (B) of the sheet P based on the moisturizing condition of FIG. 14.

First, the control section 160 makes a determination as to whether the front end of the water application area (B) of the sheet P reaches the nip portion of the pair of moisturizing rollers 231, 231 (Step S301). If not (Step S301, No), it repeats Step S301.

If the front end of the water application area (B) of the sheet P has reached the nip portion of the pair of moisturizing rollers 231, 231 (Step S301, Yes), the control section 160 slightly increases the distance between the pair of moisturizing rollers 231, 231 by means of a shifting mechanism (not shown) so as to decrease the pressure of the pair of moisturizing rollers 231, 231. The control section 160 also controls the first driver 231a to increase the rotation speed of the pair of moisturizing rollers 231, 231 from the predetermined speed (Step S302).

In this step, the rotation speed of the conveying rollers 237, 237 remains at the predetermined speed, and the pressure of the conveying rollers 237, 237 on the sheet P also remains at the original level.

Accordingly, the pair of moisturizing rollers 231, 231 slip on the surface of the sheet P. This allows bringing the water application area (B) of the sheet P into contact with the water application area (A) of the pair of moisturizing rollers 231, 231 that is longer than the water application area (B).

Next, the control section 160 makes a determination as to whether a predetermined period of time, which corresponds to the period of time required to pass the water application area (B) of the sheet P through the nip portion of the pair of moisturizing rollers 231, 231, has elapsed (Step S303). If the control section 160 determines that the predetermined period of time has not elapsed yet (Step S303, No), it repeats Step S303.

If the control section 160 determines that the predetermined period of time has elapsed (Step S303, Yes), it returns the pressure of the pair of moisturizing rollers 231, 231 to the original level by means of the shifting mechanism (not shown). The control section 160 also controls the first driver 231a to return the rotation speed of the pair of moisturizing rollers 231, 231 to the original predetermined speed (Step S304).

This allows bringing the long water application area (A) of the pair of moisturizing rollers 231, 231 into contact with the water application area (B) of the sheet P. As a result, the amount of water applied to the sheet P can be increased.

In this variation, the control section 160 controls the second driver 231b to decrease the pressure of the pair of moisturizing rollers 231, 231 and also controls the first driver 231a to increase the rotation speed of the pair of moisturizing rollers 231, 231, so that the pair of moisturizing rollers 231, 231 slip on the surface of the sheet P. However, the present invention is not limited thereto.

For example, the control section 160 may control the second driver 231b to maintain the pressure of the pair of moisturizing rollers 231, 231 at a constant pressure F2 that is less than the pressure F1 at which the conveying rollers 237, 237 pinch the sheet P. While maintaining this condition, the control section 160 controls the first driver 231a to increase the rotation speed of the pair of moisturizing rollers 231, 231 when the front end of the water application area (B) of the sheet P reaches the nip portion of the pair of moisturizing rollers 231, 231. In this way, the control section 160 can allow the pair of moisturizing rollers 231, 231 to slip on the surface of the sheet P.

### Second Embodiment

Next, a second embodiment of the present invention will be described mainly in the difference in configuration from the first embodiment. The same reference signs are denoted to the same components as those of the first embodiment, and the description thereof is omitted.

In this embodiment, according to the type of a sheet P, a control section 160 controls a third driver 232a to bring one of water feeding rollers 232, 232 into contact with one of a pair of moisturizing rollers 231, 231 so that only one side of the sheet P is moisturized.

Specifically, when the type of the sheet P is coated board paper, the control section 160 applies water only to the back side (non-coated surface) of the sheet.

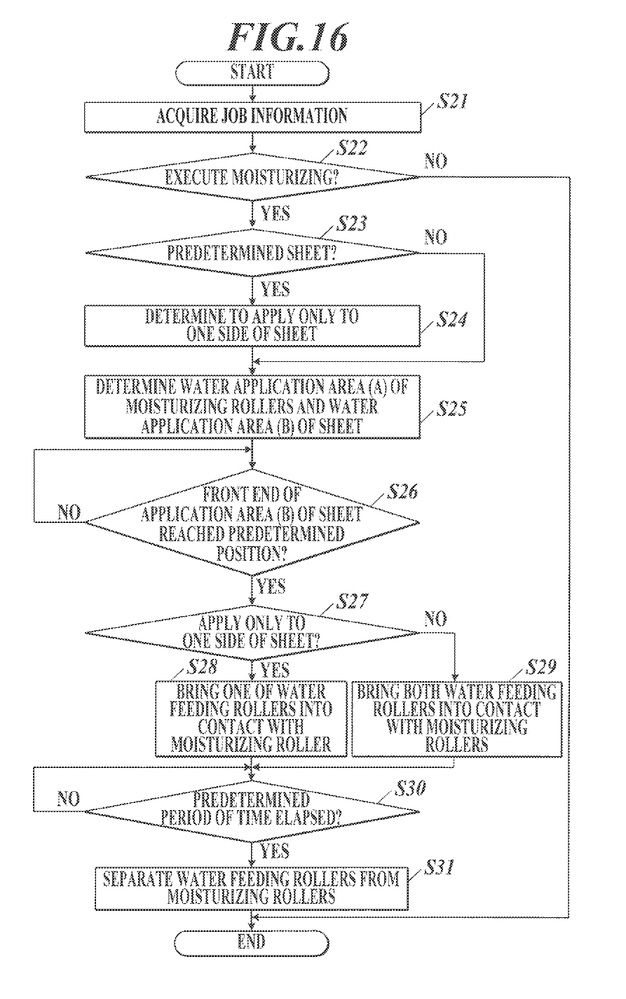

FIG. 16 is a flowchart illustrating the process of moisturizing.

In this flowchart, the type of the sheet P is coated board paper.

Step S21 and Step S22 of FIG. 16 are the same as Step S11 and Step S12 of FIG. 8, and the detailed description thereof is omitted.

If it is determined to perform the moisturizing in Step S22 (Step S22, Yes), the control section 160 makes a determination as to whether the sheet type falls into a predetermined sheet type (Step S23). If the sheet type does not fall into the predetermined sheet type (Step S23, No), the process continues with Step S25. If the sheet type falls into the predetermined sheet type (Step S23, Yes), the control section 160 determines to apply water only to one side of the sheet (Step S24).

In this case, since the type of the sheet P is coated board paper, the control section 160 determines to apply water only to the back side (non-coated surface) of the sheet P.

Then, the control section 160 determines a water application area (A) of the pair of moisturizing rollers 231, 231 and a water application area (B) of the sheet P (Step S25).

When water is applied only to one side of the sheet P, the control section 160 determines the water application area (A) of one of the pair of moisturizing rollers 231, 231 (the moisturizing roller located on the water applying side (back side) of the sheet P) and the water application area (B) of the sheet P.

The subsequent Step S26 is the same as Step S14 of FIG. 8.

In Step S26, if the front end of the water application area (B) of the sheet P has reached a predetermined position (Step S26, Yes), the control section 160 makes a determination as to whether the process in execution is a process for applying water only to one side of the sheet P (Step S27).

If the process in execution is a process for applying water only to one side of the sheet P (Step S27, Yes), the control section 160 controls the third driver 232a to bring the water feeding roller 232 (one of the water feeding rollers 232) that corresponds to the moisturizing roller 231 located at the water applying side (back side) of the sheet P into contact with this moisturizing roller 231 (Step S28), and the process continues with Step S30. If the process in execution is not a process for applying water only to one side of the sheet P (Step S27, No), the control section 160 controls the third driver 232a to bring both of the water feeding rollers 232, 232 into contact with the pair of moisturizing rollers 231, 231 (Step S29), and the process continues with Step S30.

The subsequent Step S30 is the same as Step 16 of FIG. 8.

In Step S30, if the predetermined period of time has elapsed (Step S30, Yes), the control section 160 separates the water feeding roller 232 that was in contact with the moisturizing roller 231 from this moisturizing roller 231 (Step S31).

By these steps, when the sheet P falls into the predetermined sheet type, water is applied to the water application area (A) of the moisturizing roller 231 located on the water applying side (back side) of the sheet P.

Thereafter, the application area (B) of the sheet P passes through the nip portion of the pair of moisturizing rollers 231, 231 so that water is applied to one side of the sheet P.

As described above, this embodiment produces the same advantageous effects as the first embodiment. Furthermore, as only one side of the sheet P is moisturized, this embodiment allows applying adequate sheet finishing tailored to the sheet P. In the case of a coated board paper for example, if the front side (coated surface) is moisturized, the surface is likely to repel water to form water droplets. These water droplets may be left in the sheet conveyance path in the downstream and cause adverse effects such as a paper jam when the subsequent sheet P may cling thereto. Therefore, in the case of a coated board paper, adverse effects can be avoided more surely by moisturizing only the back side (non-coated surface) of the paper.

It should be understood that the configurations of Variation 1 to Variation 3 can also be applied to this embodiment.

The above-described first and second embodiments are examples in which the sheet P is moisturized only in the water application area (B) (the area of the sheet P to which the sheet finishing is applied). Instead, in addition to the sheet finishing area, the remaining area of the sheet P may also be moisturized with a less amount of water than the amount of water applied to the sheet finishing area. That is, the moisturizing may be performed such that the amount of water applied to the sheet finishing area is greater than the amount of water applied to the other area of the sheet P.

In addition to reducing the stiffness of the sheet P in the sheet finishing area, this allows moderately moisturizing the remaining area and preventing the sheet P from overall waving by means of the de-curling section 250.

To moisturize the remaining area with a less amount of water than the amount of water applied in the sheet finishing area, the control section 160 may perform a control opposite to the control of Variation 3 of the first embodiment. That is, the control section 160 controls the first driver 231a to decrease the rotation speed of the pair of moisturizing rollers 231, 231 such that the surface speed of the pair of moisturizing rollers 231, 231 is slower than the sheet conveying speed of the sheet conveying member (e.g. the conveying rollers 237, 237).

To be more specific, for example, such controls include the following two examples. In the following description, the area that is moisturized with a less amount of water than the amount of water applied to the sheet finishing area is referred to as a water application area (C) of the sheet P.

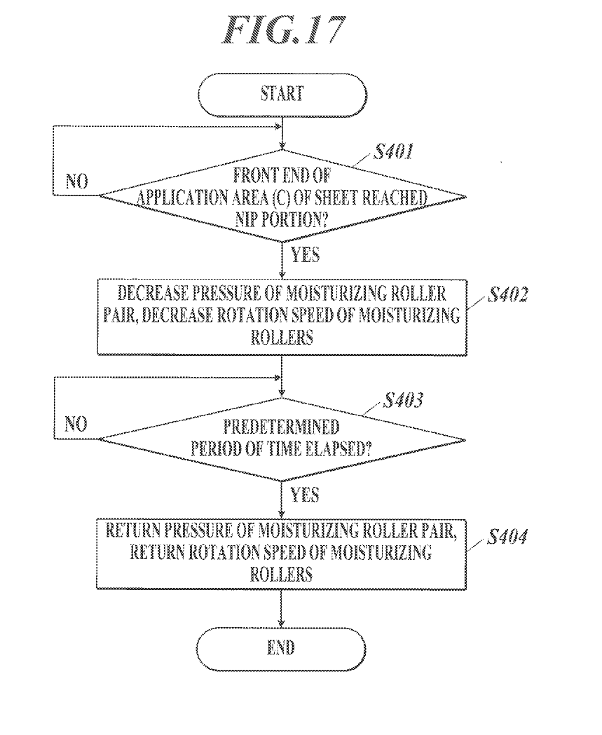

FIG. 17 is a flowchart illustrating the process of moisturizing of a first example.

If the front end of the water application area (C) of the sheet P has reached the nip portion of the pair of moisturizing rollers 231, 231 (Step S401, Yes), the control section 160 controls the second driver 231b to decrease the pressure of the pair of moisturizing rollers 231, 231 and also controls the first driver 231a to decrease the rotation speed of the pair of moisturizing rollers 231, 231 (Step S402). Step S403 and Step S404 are the same as Step S303 and S304 of FIG. 15 respectively.

In a second example, first, the control section 160 controls the second driver 231b to maintain the pressure of the pair of moisturizing rollers 231, 231 at a constant pressure F2 that is less than the pressure F1 of the conveying rollers 237, 237 pinching the sheet P. While maintaining this condition, when the front end of the water application area (C) of the sheet P reaches the nip portion of the pair of moisturizing rollers 231, 231, the control section 160 controls the first driver 231a to decrease the rotation speed of the pair of moisturizing rollers 231, 231.

By any of the above-described two controls, the pair of moisturizing rollers 231, 231 slip on the surface of the sheet P so that the length of the water application area (A) of the pair of moisturizing rollers 231, 231 is less than the length of the water application area (C) of the sheet P. As a result, the amount of water applied to the sheet P can be reduced. A combination of the above-described control with the control of the first or second embodiment allows moisturizing in which the amount of water applied is partly increased.

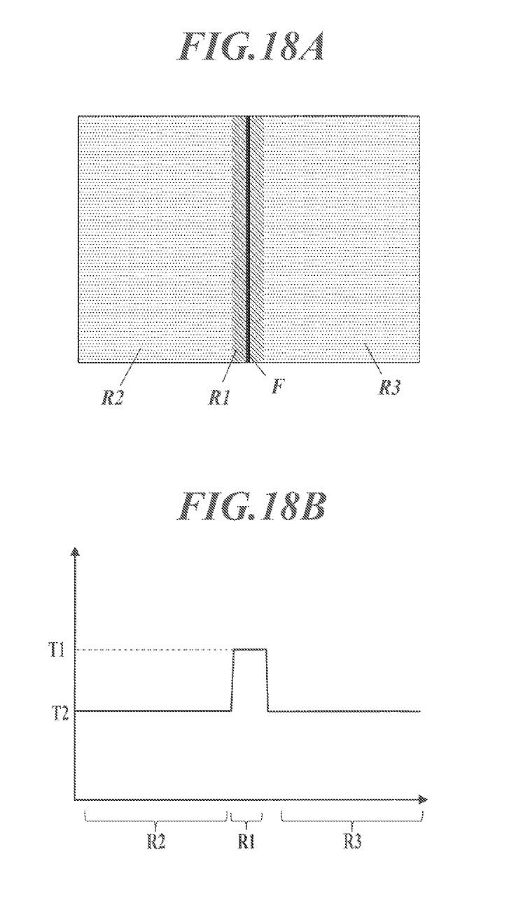

FIG. 18A is an explanatory view illustrating the moisturized condition of the sheet P in this case. In FIG. 18A, R1 is the area of the sheet P to which sheet finishing is applied, and R2 and R3 are the remaining area of the sheet P other than the sheet finishing area.

FIG. 18B is a graph illustrating the relationship between location in the sheet P in the conveying direction and amount of water applied.

As illustrated in FIG. 18B, the sheet finishing area R1 is moisturized with water in an application amount T1, which is controlled to be relatively high. Therefore, failures of the apparatus due to the sheet finishing can be prevented. In contrast, the remaining areas R2 and R3 of the sheet P other than the sheet finishing area are moisturized with water in an application amount T2, which is controlled to be relatively low. Therefore, the overall waving of the sheet P can be prevented by the de-curling section 250. By setting the application amount T2 to an adequate level, adverse effects of moisturizing on the apparatus can be prevented.

The first and second embodiments are examples in which the water feeding rollers 232, 232 feed water to the outer peripheral surface of the pair of moisturizing rollers 231, 231. However, the water feeding section is not limited to a roller and may have any configuration that can feed water to the outer peripheral surface of the pair of moisturizing rollers 231, 231.

This U.S. patent application claims priority to Japanese patent application No. 2014-125182 filed on Jun. 18, 2014, the entire contents of which are incorporated by reference herein for correction of incorrect translation.

What is claimed is:

1. A sheet moisturizing apparatus, comprising:
a moisturizing section comprising a pair of moisturizing rollers that moisturizes a sheet and a driver that rotates the pair of moisturizing rollers;
a water feeding section that feeds water to an outer peripheral surface of the pair of moisturizing rollers; and
a control section that controls the water feeding section to feed water only to a predetermined part of the outer peripheral surface of at least one of the pair of moisturizing rollers or controls the water feeding section to feed water to at least one of the pair of moisturizing rollers such that a predetermined part of the outer peripheral surface is fed with water in a greater amount than a remaining part, and thereafter allows the rotating pair of moisturizing rollers driven by the driver to pinch the sheet so as to bring the predetermined part into contact with a sheet finishing area of the sheet to which sheet finishing is applied.

2. The sheet moisturizing apparatus according to claim 1,
wherein the predetermined part of the outer peripheral surface of the pair of moisturizing rollers and the sheet finishing area of the sheet have a same length in a sheet conveying direction.

3. The sheet moisturizing apparatus according to claim 2,
wherein when a front end in the sheet conveying direction of the sheet finishing area of the sheet reaches a nip portion of the pair of moisturizing rollers, the control section controls the driver to decrease a rotation speed of the pair of moisturizing rollers.

4. The sheet moisturizing apparatus according to claim 2,
wherein when a center part in the sheet conveying direction of the sheet finishing area of the sheet reaches a nip portion of the pair of moisturizing rollers, the control section controls the driver to stop rotation of the pair of moisturizing rollers for a predetermined period of time.

5. The sheet moisturizing apparatus according to claim 1,
wherein the moisturizing section comprises a conveying member that conveys the sheet,
wherein the predetermined part of the outer peripheral surface of the pair of moisturizing rollers has a length in the sheet conveying direction greater than the sheet finishing area of the sheet, and
wherein when a front end in a sheet conveying direction of the sheet finishing area of the sheet reaches a nip portion of the pair of moisturizing rollers, the control section controls the driver to increase a rotation speed of the pair of moisturizing rollers such that a surface speed of the pair of moisturizing rollers is greater than a sheet conveying speed of the conveying member.

6. The sheet moisturizing apparatus according to claim 1,
wherein the control section controls the water feeding section to feed water only to one of the pair of moisturizing rollers according to a type of the sheet.

7. The sheet moisturizing apparatus according to claim 1,
wherein the moisturizing section further comprises a conveying member that conveys the sheet,
wherein the remaining part of the outer peripheral surface of the pair of moisturizing rollers has a length in a sheet conveying direction shorter than an area of the sheet to which a less amount of water is applied compared to the sheet finishing area, and
wherein when a front end in the sheet conveying direction of the area of the sheet to which a less amount of water is applied compared to the sheet finishing area reaches a nip portion of the pair of moisturizing rollers, the control section controls the driver to decrease a rotation speed of the pair of moisturizing rollers such that a surface speed of the pair of moisturizing rollers is less than a sheet conveying speed of the conveying member.

8. An image forming system, comprising:
an image forming apparatus that forms an image on a sheet; and
the sheet moisturizing apparatus according to claim 1, which moisturizes the sheet on which the image has been formed by the image forming apparatus.

9. The image forming system according to claim 8, further comprising:
a sheet finishing apparatus that applies sheet finishing to the sheet.

10. A sheet moisturizing apparatus, comprising:
a moisturizing section comprising a pair of moisturizing rollers that moisturizes a sheet and a driver that rotates the pair of moisturizing rollers;
a water feeding section that feeds water to an outer peripheral surface of the pair of moisturizing rollers;
an information acquiring section that acquires information on sheet finishing to be applied to the sheet;
an application area determining section that determines a water application area of the sheet to which water is applied based on the information acquired by the information acquiring section;
a water feed control section that controls the water feeding section to feed water only to a predetermined part of the outer peripheral surface of at least one of the pair of moisturizing rollers based on the area determined by the application area determining section; and
an application control section that allows the rotating pair of moisturizing rollers driven by the driver to pinch the sheet so as to bring the predetermined part into contact with a sheet finishing area of the sheet after water is fed by the water feed control section.
